(19) United States
(12) Patent Application Publication
(10) Pub. No.: US 2003/0122389 A1
(43) Pub. Date: Jul. 3, 2003

(54) Panel holding device

(76) Inventor: Jan Urbanovic, Seattle, WA (US)

Correspondence Address: Dean A. Craine, P.S., 400 - 112th Ave. NE., Suite 140, Bellevue, WA, 98004, US

(21) Appl. No.: 10/318,557

(22) Filed: Dec. 13, 2002

Related U.S. Application Data
(60) Provisional application No. 60/340,594, filed on Dec. 14, 2001.

(51) Int. Cl. B65G 7/12

(52) U.S. Cl. 294/16

(57) ABSTRACT

A carrying device used by an individual to manually carry large panels of material in a vertical position. The carrying device includes an upper curved member that includes parallel first and second gripping members. Attached to the upper curved member is a hand grip. The upper curved member is aligned perpendicularly to the first and second gripping member and the first and second gripping members are sufficiently spaced apart so that when the upper curved member is placed over the upper horizontal edge or a vertical edge on a panel and an upper force is extended on the hand grip, the first and second gripping members rotate and bind against the panel so that the panel may be carried. An optional extension arm is provided that pivotally attaches to the handle so that the device may be used to lift panels when users are standing above and a distance from the panel.

This Utility Patent Application claims the benefit of Provisional Patent Application Serial No. 60/340,594 filed on Dec. 14, 2001.

### BACKGROUND OF THE INVENTION

1. Field of the Invention

This invention pertains to carrying devices, and more particularly, to carrying devices used to manually transport large panels upright on one edge.

2. Description of the Related Art

Today, home improvement stores which attract “do-it-yourselfers” are very popular. When visiting such stores to purchase large panels of wood or sheet rock, shoppers must transport the panels from a distant storage location in the store to a checkout counter, and then to their truck or trailer. Although wheeled carts are usually available for customers to transport panels, they are difficult to steer and maneuver. This is especially true when the store is crowded with customers.

There are of course, two ways to carry a large panel in an upright, vertical orientation. First, one or more individuals can hold the large panel along the lower horizontal edge. Second, two individuals can hold the large panel's opposite vertical edges.

Devices used to manually carry large panels of plywood, sheetrock, glass etc. upright in a vertical orientation are disclosed in U.S. Pat. No. 6,113,167 (Mattis et al.), U.S. Pat. No. 5,226,688 (Russo et al.), and U.S. Pat. No. 4,013,202 (Russo et al.). All of these devices include an upper element that extends over the upper edge of the large panel and presses against the outside surface of the panel and an inside element that presses against the opposite surface of a panel. These devices have several drawbacks.

First, such devices are relatively large and impractical to use in a home improvement store.

Second, these devices cannot be used to selectively engage either a horizontal edge or a vertical edge of the panel.

Third, the individual must stand immediately adjacent to the vertically aligned panel when the upper horizontal edge is engaged by the device and lifted. The device cannot be used to lift the panel if the individual is standing on a ladder or otherwise located at a higher elevation above the panel.

A fourth drawback is that different versions of the device must be provided for right- and left-handed users. This drawback requires home improvement centers to provide two versions of the device.

What is needed is a small, lightweight, relatively simple-to-use panel-carrying device that can be used by one individual or two individuals to carry a panel along its upper horizontal edge or along the two vertical edges. What is also needed is such a device that can be easily used to transport a large panel when standing at a higher elevation of the panel. What is also needed is such a carrying device that can be used by both left- and right-handed individuals.

### SUMMARY OF THE INVENTION

It is an object of the present invention to provide a device used to transport a large panel in a vertical orientation.

It is another object of the present invention to provide such a device that can engage either a horizontal or vertical edge on the vertically oriented panel.

It is another object of the present invention to provide a device that can be used to lift panels from a lower elevation to a higher elevation when not standing adjacent to the panel.

It is another object of the present invention to provide such a device that can be used by both right- and left-handed workers.

These and other objects are met by a small, lightweight panel carrying device used by an individual to manually carry a large panel or panel of material in a vertical orientation. The device includes an upper curved member designed to be disposed over the upper or a side edge of the panel. Attached to the distal end of the upper curved member is a first gripping member that is placed over the surface of the panel opposite the user. Attached to the proximal end of the upper curved member is a hand grip member that includes a second gripping member which is disposed on the surface of the panel adjacent the user. Also attached to the hand grip member is a handle that is grasped by the user to lift the panel. The first and second gripping members are oriented parallel and are sufficiently spaced apart so that the upper curved member may be extended transversely over the outer edge of the panel. The first and second gripping members are offset on the upper curved member and the handle is located on the hand grip member slightly above the second gripping member. When the device pivots over the outer edge on the panel and a lifting force is applied to the handle, the device is pivoted around the outer edge so that first and second gripping members are forced inward against the opposite surfaces of the panel to bind the panel. When the handle is lifted by the user, the weight of the panel forces the two gripping members against the opposite sides of the panel thereby enabling the panel to be carried.

The above described device may be used by one individual to carry a single panel by positioning the device centrally on the panel and by extending the upper curved member over its top, horizontal edge. A panel may also be carried by two individuals using two devices on the opposite vertical edges. When used by one individual to carry a panel, rotational stress is applied to the back that may lead to back injuries. In order to reduce stress, an optional extension arm may be used with the device that allows a user to lift a panel with one arm extended downward and parallel to the panel. The extension arm includes a rotational connecting means for attaching to the hand grip member on the device, a lower handle and a panel resting surface. During use, the rotational connecting means connects the upper end of the extension arm to the hand grip member. The device is positioned over the top horizontal edge while the extension arm is disposed vertically over the side of the panel adjacent to the user. The user then grasps and lifts the lower handle, thereby applying a lifting force to the hand grip member to engage the first and second gripping members on the panel. The opposite or outside hand grasps the handle on the hand grip member to help bind the first and second gripping members and to stabilize the panel on the panel resting surface. When lifted, the panel is held at an angle and supported by the panel resting surface. The extension arm may also be used to lift a panel while standing above and at a distance from the panel.

### BRIEF DESCRIPTION OF THE DRAWINGS

FIG. 1 is a perspective view of an individual using the device to lift a panel of material in a vertical orientation.

FIG. 2 is a plan view of the invention placed around the upper horizontal edge of a panel of material.

FIG. 3 is a side elevational view of the invention shown in FIG. 2.

FIG. 4 is an exploded perspective view of the device.

FIG. 5 is a side elevational view of the device used on a vertical edge.

FIG. 6 is a top plan view of a second embodiment of the device.

FIG. 7 is another embodiment of the device with rotating first and second gripping members and a rotating handle.

FIG. 8 is a top plan view of a third embodiment of the device.

FIG. 9 is a side elevational view of the third embodiment shown in FIG. 8.

FIG. 10 is a side elevational view of the bucket shown in FIG. 7.

FIG. 11 is a top plan view of the bucket shown in FIG. 7.

FIG. 12 is a side elevational view of the post shown in FIG. 12.

FIG. 13 is a perspective view of the belt clip.

FIG. 14 is a front plan view of the belt clip.

FIG. 15 is a side elevational view of the belt clip.

### DESCRIPTION OF THE PREFERRED EMBODIMENT(S)

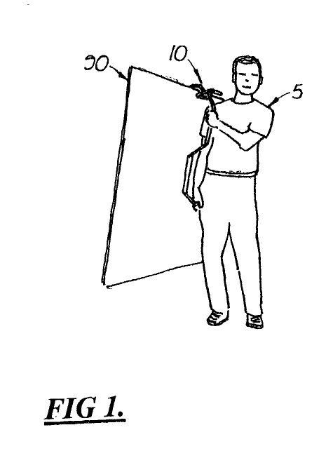

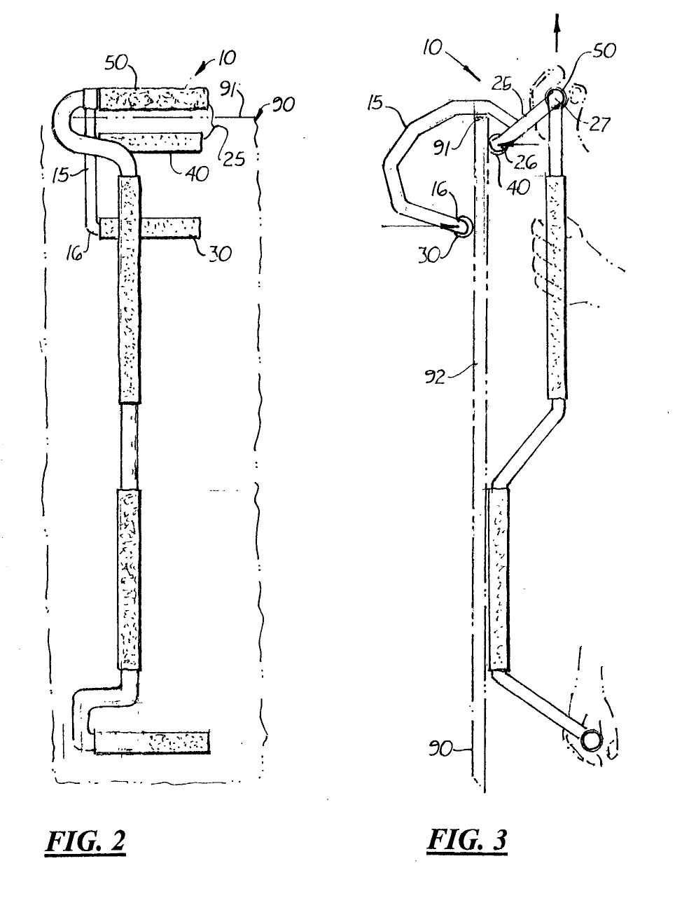

Referring to the accompanying Figs., there is shown and described a small, lightweight panel carrying device 10 used by a user 5 to manually carry a large panel 90 of material in a vertical position adjacent to his or her body. The carrying device 10 includes an upper curved member 15 with a first gripping member 30 perpendicularly aligned, and attached to its distal end 15A and a hand grip member 25 attached at its opposite proximal end 15B. In the first embodiment shown in FIGS. 1-4, the hand grip member 25 is C-shaped with a second gripping member 40 and a handle 50. The first and second gripping members 30, 40, respectively, are both parallel to the handle 50 and are sufficiently spaced so that when the upper curved member 15 is transversely aligned over a horizontal edge 91 or vertical edge 92 of the panel 90, the first and second gripping members 30, 40, respectively, are located on opposite sides of the panel 90. The upper curved member 15 extends sufficiently to extend transversely over the upper horizontal edge 91 or a vertical edge 92 of the panel 90. When an upward lifting force is applied to the handle 50 by the user 5, the first and second gripping members 30, 40, respectively, rotate inward towards the panel's surface to bind the panel 90 therebetween so that the device 10 may be used to lift and carry the panel by the user 5.

The upper curved member 15 is a semi-circular arc of approximately 180 degrees. The first gripping member 30 is perpendicularly aligned and securely attached or fixed to the distal end 15A of the upper curved member 15. The proximal end 15B of the upper curved member 15 is attached to the mid-line axis of the center leg 26 on the hand grip member 25.

In the first embodiment, the first and second gripping members 30, 40, respectively, are made of round tubular material approximately ¾″ in diameter and six inches in length. They are parallel and spaced apart approximately 5 inches. The second gripping member 40 and handle 50 are also spaced apart approximately 7 inches. The handle 50 is also tubular and approximately ¾ inches in diameter and six inches in length. As shown in FIG. 3, when used over the upper horizontal edge 91 of a panel 90, the second gripping member 40 is located slightly above the first gripping member 30. Because the hand grip member 25 is diagonally aligned on the proximal end 15B of the upper curved member 15, the handle 50 is located slightly above the second gripping member 40. In order to be used with ¼ to 1″ thick panels, the upper curved member 15 should have a diameter between 4 to 8 inches.

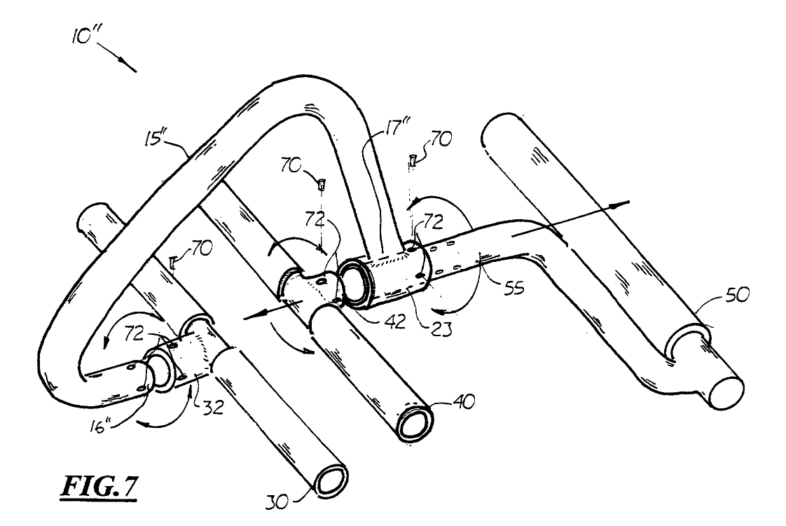

In a second embodiment, shown in FIG. 6, the hand grip member 25 in the first embodiment is replaced by a modified hand grip member 25′ designed to align the upper curved member 15 over the mid-line axis of the handle 50. As shown in FIG. 7, the proximal end 15B of the upper curved member 15 connects to the second gripping member 40. The modified grip member 25′ includes a middle section 29 that extends centrally and connects to the proximal end 15B of the upper curved member 15. By centrally aligning the upper curved member 15 over the modified hand grip member 25′, the device 10 may be more easily used by either left- or right-handed users.

FIG. 7 also shows an optional coupler 31 attached to the proximal end 15B of the upper curved member 15 that enables the hand grip 25 or modified hand grip 25′ (shown) and second gripping member 40 to independently rotate on the upper curved member 15. FIG. 7 also shows a second optional coupler 32 centrally and perpendicularly aligned on the first gripping member 30 that receives the distal end 15A of the upper curved member 15. The second gripping member 40 includes a neck 42 that connects to the straight middle section 55 attached to the handle 50 so that it slides into one end of a hollow collar 23 formed on the proximal end of the upper curved member 15″. Pins 70 are inserted into bores 72 formed on the distal and proximal ends 16″, 17″ of the modified upper curved member 15″, the first and second gripping members 30″, 40″, and the handle 50″ to hold the piece together. During use, the middle section of the handle 50″ slides into the collar 23 and is used to adjust the spacing between the first and second gripping members 30″, 40″, respectively.

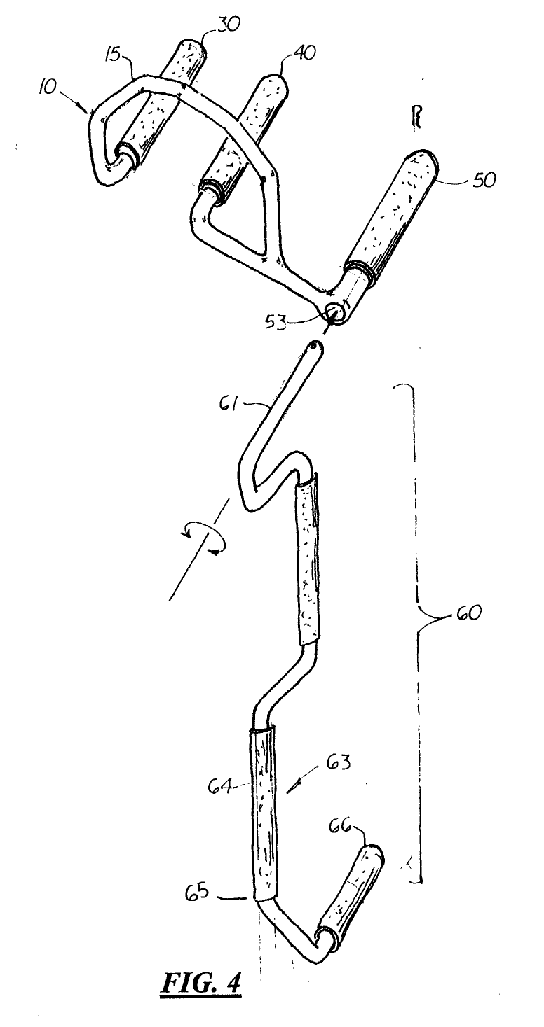

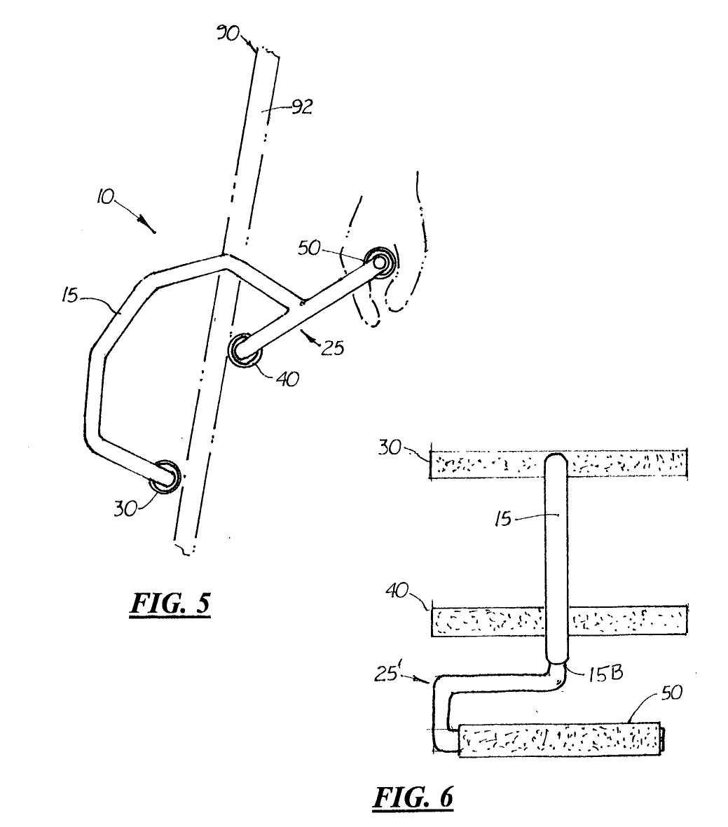

With all three embodiments, an extension arm 60, shown in FIG. 4, may be used that pivotally connects to the handle 50, 50′, 50″. The extension arm 60 includes a lower, inward extending section 63 which includes a panel support surface 64. Attached to the lower end 65 of the extension arm 60 is a lower grip handle 66 which the user grasps with a lower extending hand, as shown in FIG. 1. Formed on the upper end of the extension arm 60 is a perpendicularly aligned handle tube 61. In each embodiment, the handle 50, 50′, 50″ is hollow with an end opening 53 capable of receiving the handle tube 61 to selectively attach the extension arm 60 to the handle 50. The handle tube 61 is slightly smaller in diameter than the handle 50 thereby enabling the extension arm 60 to rotate. During use, the lower handle 66 is grabbed by the inside hand to apply a lifting force to the handle 66. The opposite, higher hand grabs the upper handle 50 and uses it to stabilize the panel 90 and to keep it close to the user's spinal axis, thereby preventing back injuries. When the panel 90 is lifted, the opposite, higher hand pulls the panel inward towards the user's spine thereby preventing rotational stress on the back. Another benefit of the extension arm 60 is that the user may lift a panel 90 when standing above and on opposite sides of the panel 90.

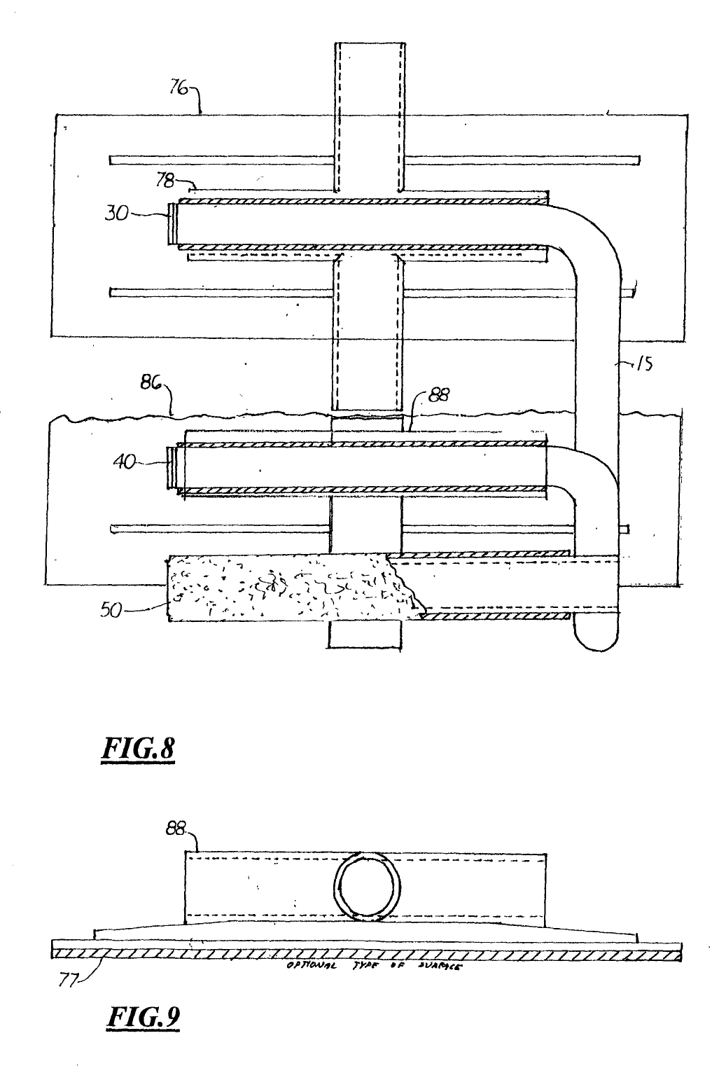

FIGS. 8 and 9 disclose an optional accessory that may be used to transport glass or other more fragile sheets. The accessory is a pair of pivoting pads 76, 86 connected to the first and second gripping members 30, 40, respectively. In the preferred embodiment, the pads 76, 86 are covered with protective covers 77 which are placed against the outside and inside surfaces of the panel 90. Tubular collar members 78, 88, designed to receive the distal and proximal ends 16, 17 of the upper curved member 15, are used to hold the pads 76, 86 on the device. 10. The collar members 78, 88 are sufficient in diameter to allow the first and second gripping members 30, 40 to hold the pads in place over the first and second gripping members 30, 40.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A panel lifting device, comprising:
a. an upper curved member, said upper curved member including a distal end and a proximal end;
b. a first gripping member perpendicularly aligned and attached to said distal end of said upper curved member;
c. a handle attached to said proximal end of said upper curved member; and,
d. a second gripping member attached to said proximal end of said upper curved member, said second gripping member aligned parallel to said first gripping member and said handle.

2. The panel lifting device, as recited in claim 1, wherein said first gripping member is an elongated tube.

3. The panel lifting device, as recited in claim 1, wherein said second gripping member is an elongated tube.

4. The panel lifting device, as recited in claim 1, wherein said handle is perpendicularly aligned with said upper curved member.

5. The panel lifting device, as recited in claim 1, further including an extension arm rotatably mounted to said handle, said extension arm including a lower handle and a panel resting surface.

6. The panel lifting device, as recited in claim 5, wherein said lower handle is perpendicularly aligned on said extension arm.

7. The panel lifting device, as recited in claim 1, further including means for allowing said handle to be selectively rotated and fixed in position on said upper curved member.

8. The panel lifting device, as recited in claim 1, further including means for allowing said second gripping member to be selectively rotated and fixed in position on said upper curved member.

9. The panel lifting device, as recited in claim 1, further including at least one pivoting pad attached to said first gripping member or said second gripping member.

10. The panel lifting device, as recited in claim 1, further including a protective cover placed over said first gripping member.

11. The panel lifting device, as recited in claim 1, further including a protective cover placed over said second gripping member.

12. A panel lifting device, comprising:
b. an upper curved member, said upper curved member including a distal end and a proximal end;
b. a first gripping member perpendicularly aligned and attached to said distal end of said upper curved member, said first gripping member being an elongated tube; and,
c. a hand grip member attached to said proximal end of said upper curved member, said hand grip member including second gripping member aligned parallel to said first gripping member and a spaced-apart handle.

13. The panel lifting device, as recited in claim 12, further including means for rotating said handle on said hand grip member.

14. The panel lifting device, as recited in claim 12, further including means for rotating said second gripping member on said hand grip member.

15. The panel lifting device, as recited in claim 12, further including at least one pivoting pad attached to said first gripping member or said second gripping member.

16. The panel lifting device, as recited in claim 12, further including a protective cover placed over said first gripping member.

17. The panel lifting device, as recited in claim 12, further including an extension arm rotatably mounted to said handle, said extension arm including a lower handle and a panel resting surface.

18. The panel lifting device, as recited in claim 12, wherein said lower handle is perpendicularly aligned on said extension arm.
